(19) United States
(12) Patent Application Publication
(10) Pub. No.: US 2005/0187055 A1
(43) Pub. Date: Aug. 25, 2005

(54) Silent chain

(75) Inventor: Kouji Morishige, Nabari City (JP)

Correspondence Address: BORGWARNER INC., 3850 HAMLIN ROAD, AUBURN HILLS, MI, 48326, US

(73) Assignee: BordWarner Morse TEC Japan K.K., Nabari City (JP)

(21) Appl. No.: 11/032,537

(22) Filed: Jan. 10, 2005

(30) Foreign Application Priority Data
Feb. 24, 2004 (JP) 2004-047543

(51) Int. Cl. F16G 13/04; F16G 13/02

(52) U.S. Cl. 474/206

(57) ABSTRACT

A silent chain comprising a plurality of inner link plates and a plurality of outer link plates. The plurality of inner link plates are interleaved and connected into a series of rows. The plurality of outer link plates are comprised of a link plate body having a front surface, a pair of apertures, a pair of teeth with inside flanks and a guide with a rear surface formed integrally with and extending from the link plate body to between the inside flanks of the pair of teeth. The outer link plates are placed outside of outermost rows of inner link plates to form guide rows and guide the chain on a sprocket. The distance between the rear surface of the guide of the outer link plate and the front surface of the link plate body of the outer link plate is greater than or equal to zero.

### REFERENCE TO RELATED APPLICATIONS

This application claims an invention, which was disclosed in Japanese application number 2004-047543, filed Feb. 24, 2004, entitled “SILENT CHAIN”. The benefit under 35 USC§ 119(a) of the Japanese application is hereby claimed, and the aforementioned application is hereby incorporated herein by reference.

### BACKGROUND OF THE INVENTION

1. Field of the Invention

The invention pertains to the field of silent chains. More particularly, the invention pertains to an improvement of the structure of the silent chain to achieve a lighter weight.

2. Description of Related Art

FIGS. 9 to 11 illustrate a prior art silent chain. FIG. 9 is a top plan view of a portion of a silent chain, FIG. 10 is a cross sectional view of FIG. 9 taken along line X-X, showing the state of the engagement with a sprocket, and FIG. 11 is a front elevational view of a guide plate of the silent chain and a cross sectional view thereof taken along line XI-XI.

As shown in prior art FIG. 9, a silent chain 100 is comprised of a plurality of link plates 102 that are interlaced in the lateral and longitudinal direction with connecting pins (not shown) that pivotably connect the link plates 102. The silent chain 100 also has a pair of guide plates 104 provided on the outermost edges thereof.

As shown in FIG. 11, the guide plate 104 is a plate with a pair of pin apertures 122 and without a crotch and thus, it does not have a tooth that engages with a sprocket. When the silent chain 100 is disposed on the sprocket, as shown in FIG. 10, the guide plates 104 are placed by the side of the side surface Sf of the sprocket S so that the travel of the silent chain 100 on the sprocket S can be guided at the time of engagement with the sprocket S.

In this way, the prior art silent chain requires guide plates that do not participate in the engagement of the sprocket. Therefore, the silent chain of the prior art is heavy due to the additional weight of the guide plates.

The present invention is directed to decreasing the weight of the entire silent chain and providing a guiding function relative to the sprocket.

### SUMMARY OF THE INVENTION

A silent chain according to the present invention includes a plurality of link plates each having a pair of teeth and pin apertures, interleaved in the lateral and longitudinal direction, and pivotably connected to each other via connecting pins inserted into the pin apertures. The silent chain also has outermost link plates that are disposed on the outermost side in the chain width direction. Each of the outermost link plates is composed of a link plate body with a pair of teeth and pin apertures and a guide portion that is formed integrally with the link plate body and disposed between the teeth of the link plate body to protrude from the side surface of the link plate body, such that the guide portion displays a guiding function relative to the sprocket during placement by the side of the side surface of the corresponding sprocket.

During engagement with the sprocket, the link plate body of the outermost link plate participates in the engagement with the sprocket, while the guide portion of the outermost link plate is placed by the side of the side surface of the sprocket to display a guiding function relative to the sprocket. Thereby, the silent chain is located at the predetermined position on the sprocket in the width direction.

The guide portion protruding between the inside flanks of the outermost link plate displays a guiding function, which eliminates the necessity for providing a guide plate, thereby decreasing the weight of the entire chain. As a result, noise and oscillation performance and power transmission efficiency during operation is improved.

In one embodiment, the inequality, d≧0 is satisfied, where d is an offset between the back surface of the guide portion and the front surface of the link plate body.

In another embodiment, the inequality, d≧c is satisfied, where d is an offset between the back surface of the guide portion and the front surface of the link plate body and c is a total clearance between the back surface of the guide portion and the side surface of the sprocket. More specifically, c is a clearance between one side surface of the sprocket and the silent chain when the silent chain is placed to the other side surface of the sprocket.

At the time of engagement with the sprocket, even when the silent chain is placed at any position on the sprocket in the width direction, the entire link plate body of the outermost link plate will come into contact with the sprocket tooth the entire time during operation, not just a portion of the link body, thereby preventing a local wear to the inside flank of the link plate body of the outermost link plate.

### BRIEF DESCRIPTION OF THE DRAWING

FIG. 1 is a top plan view of a portion of a silent chain according to an embodiment of the present invention;

FIG. 2 is a cross sectional view of FIG. 1 taken along line II-II during engagement with a sprocket;

FIG. 3 is a front elevational view of an outermost link plate constituting a silent chain of FIG. 1 and a cross sectional view thereof taken along line III-III;

FIG. 4 is an enlarged view of a portion of FIG. 2;

FIG. 5 is a front elevational view of an outermost link plate according to a first variant of the present invention and a cross sectional view thereof taken along line V-V;

FIG. 6 is a front elevational view of an outermost link plate according to a second variant of the present invention and a cross sectional view thereof taken along line VI-VI;

FIG. 7 is a front elevational view of an outermost link plate according to a third variant of the present invention and a cross sectional view thereof taken along line VII-VII;

FIG. 8 is a front elevational view of an outermost link plate according to a fourth variant of the present invention and a cross sectional view thereof taken along line VIII-VIII;

FIG. 9 is a top plan view of a portion of a prior art silent chain;

FIG. 10 is cross sectional view of prior art FIG. 9 taken along line X-X during engagement with a sprocket; and

FIG. 11 is a front elevational view of a guide plate constituting a silent chain of prior art FIG. 9 and a cross sectional view thereof taken along line XI-XI.

### DETAILED DESCRIPTION OF THE INVENTION

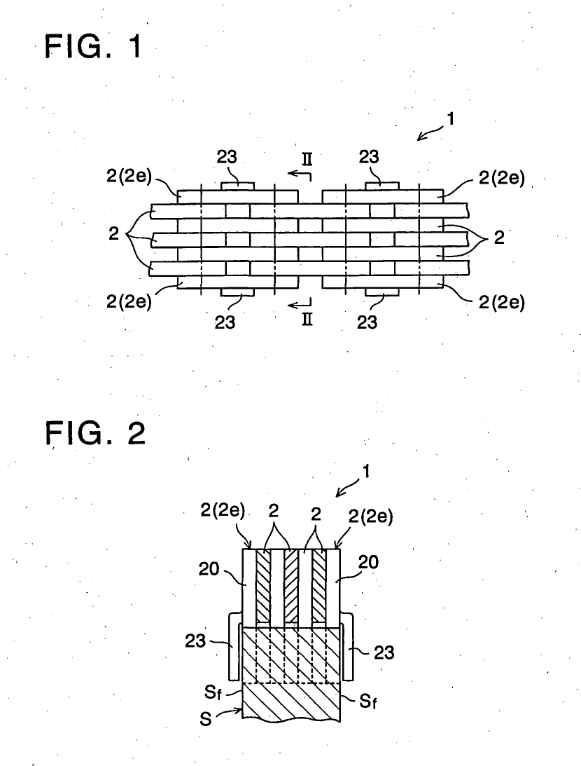

As shown in FIG. 1, a silent chain 1 is composed of a plurality of link plates 2 interleaved in the lateral and longitudinal direction and pivotably connected by connecting pins, shown only by a dashed centerline.

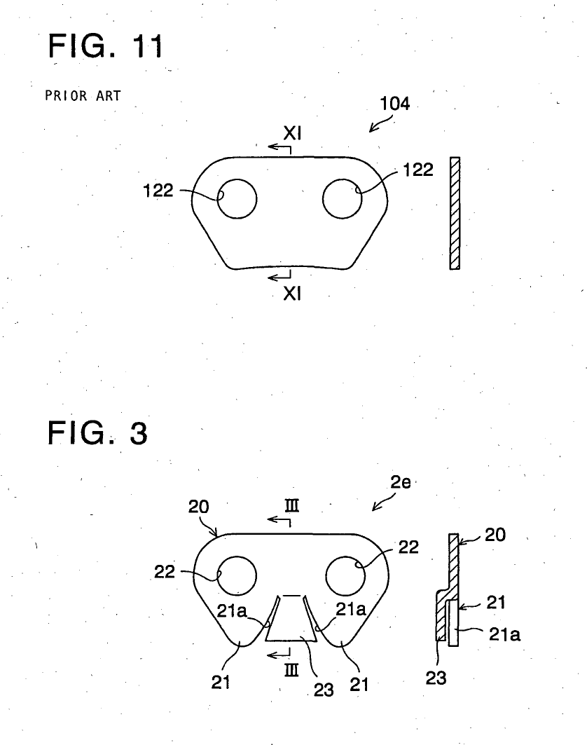

An outermost link plate 2e is disposed on the outermost side of the chain in the lateral or chain width direction. As shown in FIG. 3, the outermost link plate 2e is formed of a link plate body 20 with a pair of teeth 21 engaging with the sprocket S (see FIG. 2) having a pair of pin apertures 22 receiving connecting pins and a guide portion 23 protruding downwardly from the crotch portion of the link plate body 20 and formed integrally.

The guide portion 23 is a trapezoidal plate-like portion protruding between the adjacent inside flanks 21a of the teeth 21 of the link plate body 20. The guide portion 23 is formed on a different plane from the link plate body 20 and extends parallel to the link plate body 20. As shown in FIG. 2, at the time of engagement with the sprocket, the guide portion 23 is disposed by the side of the side surface S_{f} of the sprocket S to locate the silent chain 1 at a predetermined position on the sprocket in the lateral direction, so that it displays a guiding function of travel of the silent chain 1.

In addition, link plates 2 other than the outermost link plate 2e are not shown here, but each of these link plates 2 has a structure similar to the outermost link plate 2e with the exception of the formation of the guide portion 23. That is, each of the link plates 2 has a pair of teeth 21 and pin apertures 22 and inside flanks 21a forming a pair of teeth 21 are connected to each other at a crotch portion.

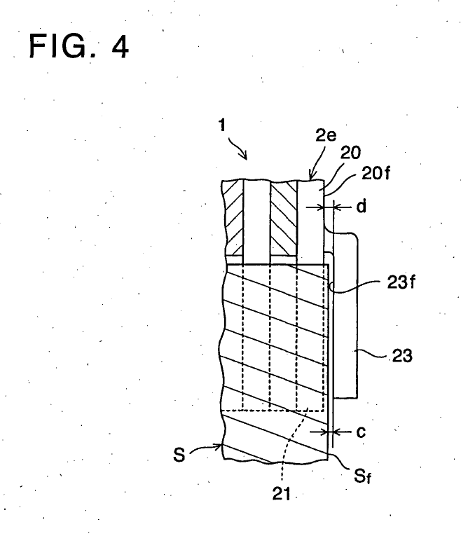

As shown in FIG. 4, when the silent chain 1 is disposed on the sprocket S, the inequality d≧0 is satisfied, where d is an offset between the back surface 23f of the guide portion 23 of the outermost link plate 2e and the front surface 20f of the link plate body 20. The back surface 23f of the guide portion 23 is flush with the front surface 20f of the link plate body 20, or a certain amount of offset is provided between the back surface 23f of the guide portion 23 and the front surface 20f of the link plate body 20.

Also, when the silent chain 1 is placed to one side surface of the sprocket S, the inequality d≧c is satisfied, where c is a clearance between the back surface 23f of the guide portion 23 of the outermost link plate 2e and the other side surface S_{f} of the sprocket S, i.e. the total clearance between the silent chain and the sprocket.

In the above-mentioned silent chain 1, at the time of engagement with the sprocket S, the teeth 21 of the link plate body 20 of the outermost link plate 2e participates in the engagement with the sprocket S (see FIG. 4), whereas the guide portion 23 of the outermost link plate 2e is placed by the side of the side surface S_{f} of the sprocket S and displays a guiding function relative to the sprocket S. Thereby, the silent chain 1 is located at a predetermined position on the sprocket S in the lateral direction to guide the travel of the silent chain 1.

The guide portion 23 that protrudes between the inside flanks 21a of the outermost link plate 2e displays a guiding function, which eliminates the necessity for providing a guide plate, thereby reducing the entire weight of the silent chain. As a result, noise and oscillation performance and power transmission efficiency in operation can be advanced.

Also, in this case, since the inequality d≧c is satisfied, even when the silent chain 1 is placed at any position on the sprocket S in the lateral direction during engagement with the sprocket, the outermost link plate 2e of the silent chain 1 engages with the sprocket tooth not partially but entirely on the engagement surface of the inside flank, thereby preventing a local wear to the outermost link plate 2e.

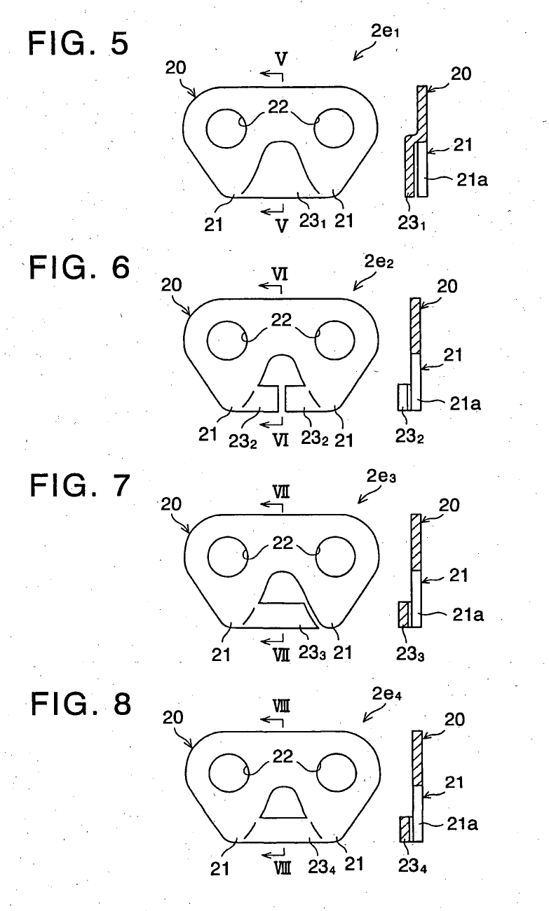

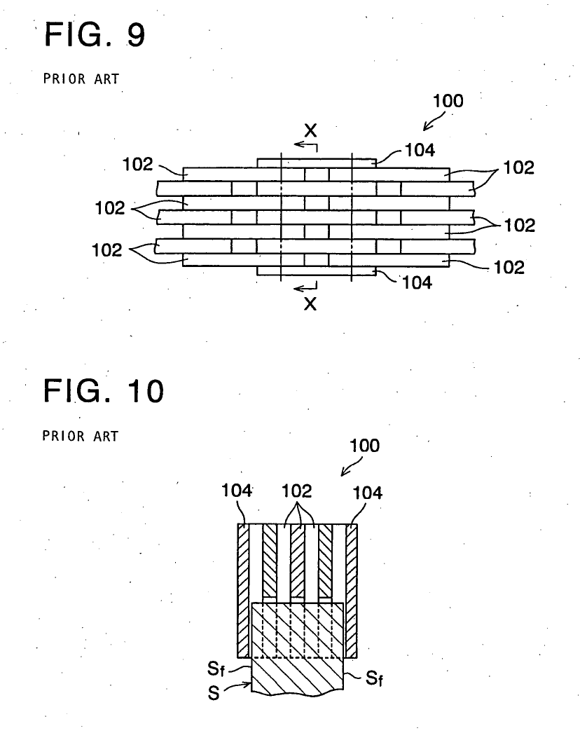

Variants of the outermost link plate will be explained using FIGS. 5 to 8. In these figures, like reference numbers indicate identical or functionally similar elements. Also, in each of the variants, the shape of the link plate body of the outermost link plate is similar to that in the above-mentioned embodiment and only the shape of the guide portion differs from that of the above-mentioned embodiment.

<First Variant>

FIG. 5 is a front elevational view of an outermost link plate according to a first variant of the present invention and a cross sectional view thereof taken along line V-V. In the above-mentioned embodiment, there is a gap formed between the opposite end surfaces of the guide portion 23 and the corresponding inside flank 21a, and guide portion 23 is cut away from the teeth 21 of the link plate body 20. In the outermost link plate 2e₁ shown in this first variant, the opposite end surfaces of the guide portion 23, is connected to and integrally formed with the inside flank 21a.

<Second Variant>

FIG. 6 is a front elevational view of an outermost link plate according to a second variant of the present invention and a cross sectional view thereof taken along line VI-VI. In the above-mentioned embodiment, the guide portion 23 extends downwardly from the crotch portion between the adjacent teeth 21, but in the outermost link plate 2e₂ shown in this second variant, a guide portion is composed of a pair of guide portions 232 each extending sideways in opposite directions from each of the teeth 21.

<Third Variant>

FIG. 7 is a front elevational view of an outermost link plate according to a third variant of the present invention and a cross sectional view thereof taken along line VII-VII. In the above-mentioned second variant, a guide portion is composed of a pair of guide portions 232 each extending sideways from each of the teeth 21, but in the outermost link plate 2e₃ shown in this third variant, a guide portion is composed of a single guide portion 233 extending beyond the link centerline from one of the teeth 21.

<Fourth Variant>

FIG. 8 is a front elevational view of an outermost link plate according to a fourth variant of the present invention and a cross sectional view thereof taken along line VIII-VIII. In the above-mentioned second variant, a gap is formed between the tip ends of a pair of guide portions 23₂ extending sideways from the teeth portions 21. Also, in the above-mentioned third variant, a gap is formed between the tip end of a single guide portion 23₃ extending from one of the teeth 21 and the inside flank of the other of the teeth 21. In the outermost link plate 2e₄ shown in this fourth variant, a guide portion is composed of a guide portion 23₄ spanning through the space between the adjacent teeth 21 to interconnect them.

In any of the above-mentioned variants, as with the above-mentioned embodiment, each guide portion displays a guiding function relative to the sprocket at the time of engagement with the sprocket, which eliminates the need to provide a guide plate. Thereby, the weight of the whole chain is reduced and thus, noise and oscillation performance and power transmission efficiency in operation can be improved.

Those skilled in the art to which the invention pertains may make modifications and other embodiments employing the principles of this invention without departing from its spirit or essential characteristics particularly upon considering the foregoing teachings. The described embodiments and examples are to be considered in all respects only as illustrative and not restrictive. The scope of the invention is, therefore, indicated by the appended claims rather than by the foregoing description. Consequently, while the invention has been described with reference to particular embodiments and examples, modifications of structure, sequence, materials and the like would be apparent to those skilled in the art, yet fall within the scope of the invention.

1. A silent chain comprising a plurality of inner link plates, each having a pair of apertures, and an pair of teeth, the inner link plates being interleaved and connected into a series of rows by connecting pins received by the pair of apertures, the chain further comprising:
a plurality of outer link plates comprising a link plate body having a front surface, a pair of apertures, a pair of teeth with inside flanks and a guide formed integrally with and extending from the link plate body, wherein the outer link plates are placed outside of outermost rows of inner link plates to form guide rows and guide the chain on a sprocket.

2. The silent chain of claim 1, wherein the guide has a rear surface and extends out from the link plate body to between the inside flanks of the pair of teeth.

3. The silent chain of claim 2, wherein a first distance between the rear surface of the guide of the outer link plate and the front surface of the link plate body of the outer link plate is greater than or equal to zero.

4. The silent chain of claim 3, wherein the first distance between the rear surface of the guide of the outer link plate and the front surface of the link plate body of the outer link plate is greater than or equal to a second distance between the rear surface of the guide of the outer link plate and a side of the sprocket.

5. The silent chain of claim 2, wherein the guide is a trapezoidally shaped.

6. The silent chain of claim 1, wherein the guide extends out and is integrally formed from the inside flanks of the pair of teeth.

7. The silent chain of claim 6, wherein the guide extends from the inside flank of one tooth to the inside flank of the other tooth.

8. The silent chain of claim 1, wherein the guide extends out and is integrally formed from one of the inside flanks of the pair of teeth.

9. A silent chain comprising:
a plurality of inner link plates each having a pair of apertures and a pair of teeth, the inner link plates being interleaved and connected into a series of rows by connected pins received by the pin apertures; and
a plurality of outer link plates comprising a link plate body having a front surface, a pair of apertures, a pair of teeth with inside flanks and a guide with a rear surface formed integrally with and extending from the link plate body to between the inside flanks of the pair of teeth, wherein the outer link plates are placed outside of outermost rows of inner link plates to form guide rows and guide the chain on a sprocket;
wherein a first distance between the rear surface of the guide of the outer link plate and the front surface of the link plate body of the outer link plate is greater than or equal to zero; and
wherein the first distance between the rear surface of the guide of the outer link plate and the front surface if the link plate body is greater than or equal to a second distance between the rear surface of the guide of the outer link plate and a side of the sprocket.

10. The silent chain of claim 9, wherein the guide is a trapezoidally shaped.

11. The silent chain of claim 9, wherein the guide extends out and is integrally formed from the inside flanks of the pair of teeth.

12. The silent chain of claim 11, wherein the guide extends from the inside flank of one tooth to the inside flank of the other tooth.

13. The silent chain of claim 9, wherein the guide extends out and is integrally formed from one of the inside flanks of the pair of teeth.
